(19) United States
(12) Patent Application Publication
(10) Pub. No.: US 2006/0100891 A1
(43) Pub. Date: May 11, 2006

(54) System and method for pricing products and maintenance /administration service cost

(75) Inventors: Asako Koyanagi, Tokyo (JP); Masanori Takamoto, Tokyo (JP); Yo Osawa, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 11/189,806

(22) Filed: Jul. 27, 2005

(30) Foreign Application Priority Data
Nov. 5, 2004 (JP) 2004-321612

(51) Int. Cl. G06Q 99/00

(52) U.S. Cl. 705/1

(57) ABSTRACT

An assisting system for pricing products and maintenance/administration service costs is provided which includes: a project data storing section for storing data regarding business contents; a task requirement defining section for decomposition into task units for which risks can be individually assessed based on data regarding contents of the complex total business structure; a cost and risk data storing section for storing cost and risk information regarding tasks to be executed in the business which occur during the term of a contract; a risk type determining section for determining assessing means while correlating respective tasks to be executed in the business which occur during the term of a contract with cost and risk data stored in the cost and risk data storing section; and a total cost and risk assessing section for calculating tasks to be executed in the business which occur during the term of a contract.

### CROSS-REFERENCE TO RELATED APPLICATIONS

This application claims the foreign priority benefit under Title 35, United States Code, § 119 (a)-(d), of Japanese Patent Application No. 2004-321612, filed on Nov. 5, 2004 in the Japan Patent Office, the disclosure of which is herein incorporated by reference in its entirety.

### BACKGROUND OF THE INVENTION

1. Field of the Invention

The present invention relates to a system and method for pricing products and maintenance/administration service costs for supporting a value-setting assessment of a total business for selling products and maintaining/administrating these sold products, in particular, for providing maintenance for a predetermined period from the sale of products including a contract agreement to guarantee a normal operation of the products and product performance.

2. Description of the Prior Art

When drawing up a business plan such as a new project, based on goods necessary for setting up the new project, contents of operation when setting up the new project, and a period of operation required for setting up the new project, etc., an estimation assessment operation to calculate costs necessary for setting up the new project is necessary. As such a method for calculating and estimating costs necessary for setting up a project business, there has been proposed an estimation assessment supporting system for supporting estimation so that a further improvement in estimation accuracy can be realized by taking factors which have an influence on development productivity as productivity characteristic items to digitize those and pointing out inferior items by comparing estimation data of an assessing object with performance data having equivalent values of productivity characteristics items (see Japanese Published Unexamined Patent Application No. 2003-280901 (Page 3, FIG. 1), for example). According to this document, accumulated performance data of a project which has already been developed is digitized in terms of project characteristic items and productivity characteristic items, performance data whose project characteristic items are similar is grouped, and for this group, the project characteristic items are digitized to become group assessment characteristics, estimation data of an assessing object is also digitized in terms of the project characteristic items and productivity characteristic items, first, values of the project characteristic items are compared with the group assessment characteristic values for a group assessment, performance data closest to a total value of the productivity characteristic items of the estimation data is extracted to compare both data in values of the respective productivity characteristic items, so that assessment is carried out from the perspective of productivity.

The above-mentioned document is for carrying out an estimation assessment, in terms of execution of a project or business based on fixed tasks, by a comparison of productivity with performance data of an existing project while also taking quantitative assessment measures such as the skill level of development personnel and the degree of technical difficulty into consideration. In the case of this project or business, for fixed tasks, an execution thereof under prescribed plans is scheduled, and estimation thereof is usually assessed as values which have been built up based on those task requirements and plans. The above-mentioned document is for assessing estimation accuracy from the perspective of productivity in response to the respective tasks.

However, when projects or businesses range widely as in the present time, some service businesses have complex total business structures such as to provide, in addition to provision of scheduled goods and operations, maintenance services including provision of substitutes for unscheduled product failures and accidents which occur during the term of a contract and repairs of failed products and the like, and guarantees of performance of the products and business results during the term as well as undertaking such maintenance and the like.

In a business contract regarding a business with such a complex total business structure, it is impossible to specify, in advance, all the contents to be provided during the term of a contract such as contents of product failures which occur during the term of a contract, frequencies of product failures, frequencies of provision of substitutes for accidents, and frequencies of repairs of failed products. Therefore, by the mere buildup of estimates of individual supplies and operations, a contract price for a business of a complex structure cannot be assessed.

In addition, in a case of a contract regarding a business of a complex total business structure, product performance and business results are influenced by service contents and maintenance conditions during the term of a contract such as failure rates of contracted equipment, failure rates of contracted facilities, maintenance of contracted equipment or facilities, and measures against failures of contracted equipment or facilities. Therefore, in the case of a contract regarding a business of a complex total business structure, a quantitative assessment according to the contractual conditions cannot be carried out by a mere consideration of only defect rates unique to the contracted equipment or facilities or failure rates unique to the contracted equipment or facilities.

On the other hand, since services to cope with unscheduled events which occur during the term of a contract and a product performance guarantee in a business of a complex total business structure is for the purpose of reducing business risks of customers, an effect of a reduction in business risks of customers can be important marketing information, however, a quantitative assessment of a risk reduction effect of complex services is difficult.

In addition, when making a contract of a service business for a business with such a complex total business structure, if there is no clear description concerning the scope of services provided, preconditions for services to be provided, the scope of responsibilities of a service provider, the scope of responsibilities of a service receiver, contents of guarantees and the like in the written contract, when an unscheduled event occurs during the term of a contract, appropriate measures may not be taken against the event that has occurred, or there is a possibility of variance between the service provider and service receiver in the understanding of the contents of services.

### SUMMARY OF THE INVENTION

An object of the present invention is to provide a system and method for pricing products and maintenance/administration service costs which can set a contract price over an extended period of time based on a cost and risk assessment including not only contents of tasks scheduled during a long term contract in a business of a complex total business structure and contents of tasks to cope with unscheduled events during a long term contract, but also provision costs for replacement goods and provision costs for maintenance operations which can occur, during the term of a contract, in addition to the contents of tasks.

Another object of the present invention is to provide a system and method for pricing products and maintenance/administration service costs which can assess the influence of forecasted failures of equipment, forecastable accidents of the entire business, and countermeasures against these failures and accidents on performance of object equipment and facilities and business results so as to set guaranteed equipment performance, amounts of compensation for failures and accidents, and incentives.

Still another object of the present invention is to provide a system and method for pricing products and maintenance/administration service costs which can support, during a long term contract of a business of a complex total business structure, promotion of a business of a complex total business structure by calculating and providing a customer risk reduction effect in addition to scheduled contents of tasks and contents of tasks to cope with unscheduled events.

Another object of the present invention is to provide a system and method for pricing products and maintenance/administration service costs which can support, during a long term contract of a business of a complex total business structure, preparation of a written contract in which the scope of and preconditions for services provided, the scope of responsibilities of a service provider and a service receiver, contents of guarantees and the like have been clearly described.

A feature of the present invention is that a business assessment supporting system for supporting preparation of a written business contract by quantitatively assessing costs and risks which may occur for a fixed period of business from a start of business based on business plans, includes:

a project data storing section for storing data regarding contents of a business of a complex total business structure;

a task requirement defining section for decomposition into task units for which risks can be individually assessed based on data regarding contents of a business of a complex total business structure stored in the project data storing section;

a cost and risk data storing section for storing cost and risk information regarding tasks to be executed in the business of a complex total business structure which occur during the term of a contract;

a risk type determining section for determining assessing means while correlating respective tasks to be executed in the business of a complex total business structure which occur during the term of a contract defined by the task requirement defining section, with cost and risk data stored in the cost and risk data storing section; and

a total cost and risk assessing section for calculating tasks to be executed in the business of a complex total business structure which occur during the term of a contract.

Another feature of the present invention is that tasks for scheduled events during a term of execution of the business of a complex total business structure and tasks for unscheduled events during the term of execution of the business of a complex total business structure are assessed in order of execution,

a distribution of costs resulted from execution of tasks for scheduled events during the term of execution of the business of a complex total business structure, a distribution of costs resulted from execution of tasks for unscheduled events during the term of execution of the business of a complex total business structure, a distribution of the influence on the business performance owing to execution of tasks for scheduled events during the term of execution of the business of a complex total business structure, and a distribution of the influence on the business performance owing to execution of tasks for unscheduled events during the term of execution of the business of a complex total business structure are estimated, and

a compensation cost is estimated by checking the calculated influence on the business performance of the business of a complex total business structure against guarantee conditions,

so that the total cost and risks are estimated to calculate a contractor loss distribution according to a contract price and a customer risk reduction effect according to contract conditions.

Still another feature of the present invention is that the system further includes: a written contract template storing section for storing contract documents corresponding to standard task contents of the business of a complex total business structure; a written contract linking means for calling up a corresponding contract document out of written contract templates stored in the written contract template storing section according to requirements inputted into the task requirement defining section and preparing a written contract requirement, and a written contract regulating section for regulating a written contract format by accepting an addition and revision to the written contract requirement prepared by the written contract linking means.

Other features of the present invention will be described in the following embodiments.

According to the present embodiment, it becomes possible, during a long term contract of a business of a complex total business structure, to support a contract price setting for a complex total business structure by calculating and providing a customer risk reduction effect based on a cost and risk assessment including not only scheduled contents of tasks and contents of tasks to cope with unscheduled events, but also provision costs for goods and operations which can occur during the term of a contract.

In addition, according to another aspect of the present embodiment, it becomes possible to assess the influence of forecasted failures of equipment, forecastable accidents of the entire business, and countermeasures against these failures and accidents on performance of object equipment and an object facility and business results so as to set guaranteed equipment performance, amounts of compensation for failures and accidents, and incentives. Furthermore, according to the present embodiment, it becomes possible, for the entire period of business, to support a business of a complex total business structure by showing a customer risk reduction effect in addition to contents of tasks scheduled during a term of execution of a business of a complex total business structure and contents of tasks to cope with unscheduled events.

Furthermore, according to still another aspect of the present embodiment, it becomes possible, during a long term contract of a business of a complex total business structure, to support preparation of a written contract in which the scope of and preconditions for services provided, the scope of responsibilities of a provider and a receiver, contents of guarantees and the like have been clearly described.

The present invention is realized by: estimating a total cost and risks by assessing tasks for scheduled events and unscheduled events during a term of execution of a business of a complex total business structure in order of execution, estimating distributions of costs resulted from execution of tasks for scheduled events and unscheduled events and distributions of the influence on a business performance owing to execution of respective tasks, and estimating a compensation cost by checking the influence on the business performance against guarantee conditions so as to calculate a contractor loss distribution according to a contract price and a customer risk reduction effect according to contract conditions; and thereby assessing, in advance, costs and risks involved in the business to quantitatively assess risks according to a contract price.

### DESCRIPTION OF THE DRAWINGS

FIG. 1 is a block diagram showing a system configuration example for carrying out the present invention;

FIG. 2 is a flowchart showing routines executed by respective means of FIG. 1;

FIG. 3 is an explanatory diagram schematically showing the contents of project data;

FIG. 4 is an explanatory diagram schematically showing the contents of cost and risk data;

FIG. 5 is an explanatory diagram schematically showing relationships between tasks and risks;

FIG. 6 is a block diagram showing another system configuration example for carrying out the present invention;

FIG. 7 is a flowchart showing routines executed by respective means of FIG. 2;

FIG. 8 is a block diagram showing an example of a hardware system of an information processor used for supporting a business assessment according to the present invention; and

FIG. 9 is a diagram showing databases of a storage device illustrated in FIG. 8.

### DESCRIPTION OF THE PREFERRED EMBODIMENTS

### Embodiment 1

Hereinafter, an embodiment of a system and method for pricing products and maintenance/administration service costs according to the present invention will be described in detail.

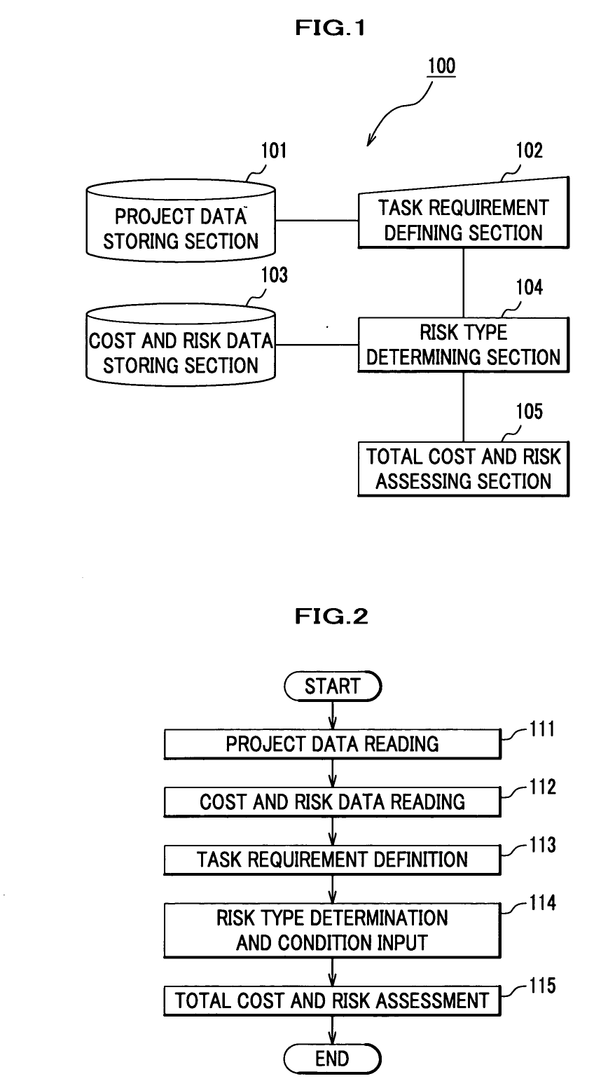

FIG. 1 shows a configuration of a system and method for pricing products and maintenance/administration service costs according to the present invention.

In FIG. 1, a business assessment supporting system 100 includes a project data storing section 101, a task requirement defining section 102, a cost and risk data storing section 103, a risk type determining section 104, and a total cost and risk assessing section 105.

The project data storing section 101 is for storing data regarding business contents, that is, data regarding business contents (for example, equipment delivered in a thermal power plant and its maintenance/inspection and repair works in general) for a complex total business structure (for example, a thermal power plant business).

The task requirement defining section 102 is for inputting thereinto objects of assessment (for example, periodic inspection times of a turbine used for a thermal power plant business, replacement times of repaired parts and the like) for the business contents (for example, maintenance/inspection and repair works in general of equipment delivered in a thermal power plant) in the complex total business structure (for example, a thermal power plant business) stored in the project data storing section 101.

The cost and risk data storing section 103 is for storing cost and risk information regarding tasks (contents of execution) which occur during the term of a contract concerning the business contents (for example, equipment delivered in a thermal power plant and its maintenance/inspection and repair works in general) for the complex total business structure (for example, a thermal power plant business).

The risk type determining section 104 is for determining assessments (task prices) while correlating respective tasks to be executed in the business (for example, equipment delivered in a thermal power plant and its maintenance/inspection and repair works in general) for the complex total business structure (for example, a thermal power plant business) which occur during the term of a contract defined in the task requirement defining section 102 with the cost and risk data stored in the cost and risk data storing section 103.

The total cost and risk assessing section 105 is for calculating all costs (expenses required for maintenance/inspection and repair works) and risks (failure rates) for a fixed period (for example, the term of a contract regarding business contents (for example, equipment delivered in a thermal power plant and its maintenance/inspection and repair works in general) of a complex total business structure (for example, a thermal power plant business)).

FIG. 2 shows an outline of contents of processes executed by the business assessment supporting system 100 illustrated in FIG. 1. In FIG. 2, first, in step 111, data regarding business contents, that is, data regarding business contents (for example, equipment delivered in a thermal power plant and its maintenance/inspection and repair works in general) for a complex total business structure (for example, a thermal power plant business) is read into the project data storing section 101. After reading data regarding a complex total business structure into the project data storing section 101 in this step 111, in step 112, cost and risk information regarding tasks (contents of execution) which occur during the term of a contract concerning the business contents (for example, equipment delivered in a thermal power plant and its maintenance/inspection and repair works in general) for the complex total business structure (for example, a thermal power plant business) is read into the cost and risk data storing section 103.

After reading cost and risk information regarding tasks (tasks executed in advance in the business) which occur during the term of a contract concerning the business contents of the complex total business structure into the cost and risk data storing section 103 in this step 112, in step 113, by the task requirement defining section 102, based on data regarding the business contents (for example, maintenance/inspection and repair works in general of equipment delivered in a thermal power plant) in the complex total business structure (for example, a thermal power plant business) stored in the project data storing section 101, contents of a contract are defined while being decomposed into units of tasks (execution of maintenance/inspections and repairs) for which risks can be individually assessed. Thereby, the contents and scope of the contract are structurally clarified, and the respective tasks and cost and risk data can be linked.

After defining while decomposing contents of a contract into task units for which risks can be individually assessed, by the task requirement defining section 102, based on data regarding the business contents in the complex total business structure stored in the project data storing section 101 in this step 113, in step 114, the risk type determining section 104 determines assessments (task prices) while correlating respective tasks to be executed in the business (for example, equipment delivered in a thermal power plant and its maintenance/inspection and repair works in general) for the complex total business structure (for example, a thermal power plant business) which occur during the term of a contract defined in the task requirement defining section 102 with the cost and risk data stored in the cost and risk data storing section 103, determines risk assessing methods for the individual tasks, and gives necessary data to the total cost and risk assessing section 105.

After the risk type determining section 104 determines assessments while correlating respective tasks to be executed in the business for the complex total business structure which occur during the term of a contract defined in the task requirement defining section 102 with the cost and risk data stored in the cost and risk data storing section 103, it determines risk assessing methods for the individual tasks, and gives necessary data to the total cost and risk assessing section 105 in this step 114, in step 115, all costs and risks (failure rates) during the term of a contract regarding business contents for a fixed period are calculated by the total cost and risk assessing section 105.

As such, the business assessment supporting system 100 makes it possible, for the entire period of a business, to assess costs and risks including not only scheduled contents of tasks and contents of tasks to cope with unscheduled events, but also provision costs for goods and operations which can occur during the term of a contract.

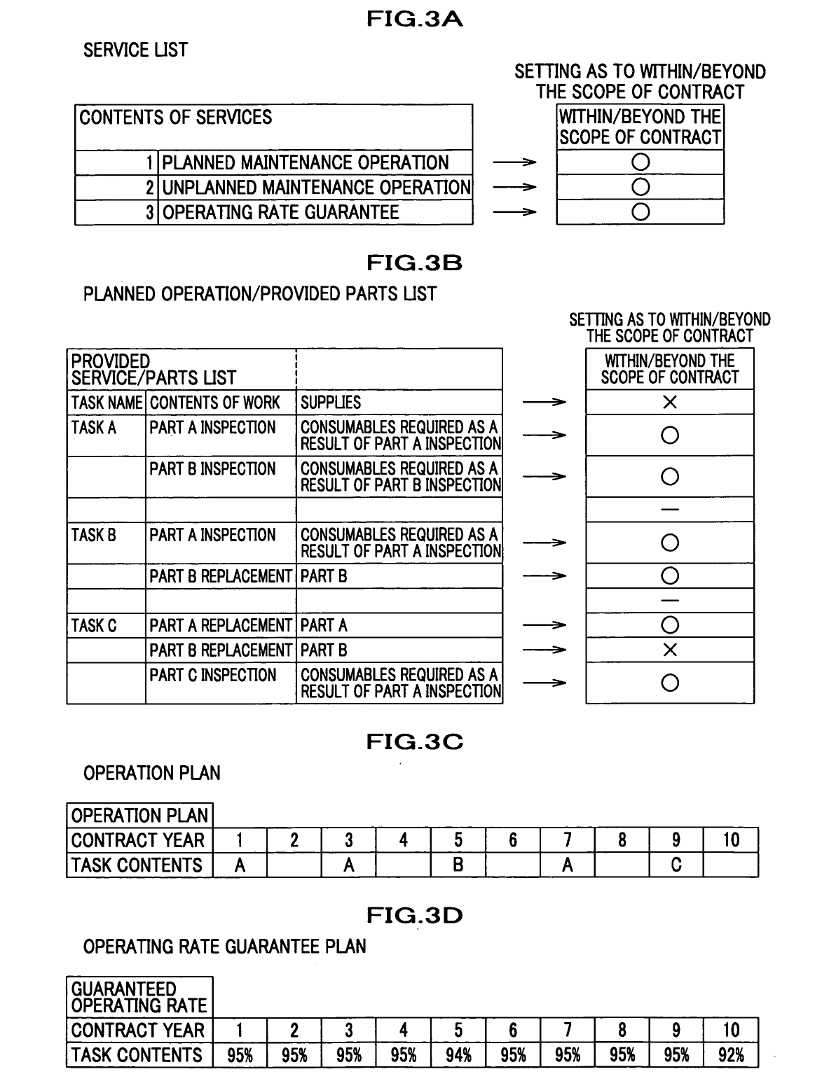

FIG. 3 shows examples of data regarding business contents in a complex total business structure stored in the project data storing section 101. As these business contents, for example, a case of a long-term maintenance contract agreement (for example, a maintenance contract agreement for equipment delivered in a thermal power plant and its maintenance/inspection and repair works in general) is exemplified.

FIG. 3A shows an example of data regarding business contents (for example, equipment delivered in a thermal power plant and its maintenance/inspection and repair works in general) in a complex total business structure (for example, a thermal power plant business). In this FIG. 3A, as the business contents, for example, a case of a long-term maintenance contract agreement (for example, a maintenance contract agreement for equipment delivered in a thermal power plant and its maintenance/inspection and repair works in general) is exemplified.

In FIG. 3A, an example of a provided service list is shown, and this contract example of FIG. 3A contains a maintenance operation to be executed in a planned manner during the term of a contract (service 1: planned maintenance operation), a maintenance operation to cope with an event that has occurred in an unplanned manner (service 2: unplanned maintenance operation), and a guarantee of an operating rate of object equipment (service 3: operating rate guarantee) as service items. These services 1 to 3 illustrated in FIG. 3A are entirely matters within the scope of the contract.

In FIG. 3B, an example of a planned operation/provided parts list is shown, and this planned operation/provided parts list example shows task items (task names) of maintenance operations applied to equipment (for example, a turbine) to be an object, contents of operation (operations) suitable for those task items, and parts (supplies) used (provided) when performing operations suitable for the task items as a provided service/provided parts list.

Namely, in FIG. 3B, in Task A of “TASK NAME,” an inspection of Part A and an inspection of Part B are executed as “CONTENTS OF OPERATION,” and in the inspection of Part A of “CONTENTS OF OPERATION,” consumable(s) required as a result of the inspection of Part A are provided as supplies, and in the inspection of Part B of “CONTENTS OF OPERATION,” consumable(s) required as a result of the inspection of Part B are provided as supplies. Execution of an inspection of Part A and an inspection of Part B as “CONTENTS OF OPERATION” in this Task A of “TASK NAME” is entirely matters within the scope of the contract.

In addition, in FIG. 3B, in Task B of “TASK NAME,” an inspection of Part A and a replacement of Part B are executed as “CONTENTS OF OPERATION,” and in the inspection of Part A of “CONTENTS OF OPERATION,” consumable(s) required as a result of the inspection of Part A are provided as supplies, and in the replacement of Part B of “CONTENTS OF OPERATION,” Part B which is required to replace Part B is provided as a supply. Execution of an inspection of Part A and a replacement of Part B as “CONTENTS OF OPERATION” in this Task B of “TASK NAME” is entirely matters within the scope of the contract.

Furthermore, in FIG. 3B, in Task C of “TASK NAME,” replacement of Part A, a replacement of Part B, and an inspection of Part C are executed as “CONTENTS OF OPERATION,” and in the replacement of Part A of “CONTENTS OF OPERATION,” Part A which is required to replace Part A is provided as a supply, in the replacement of Part B of “CONTENTS OF OPERATION,” Part B which is required to replace Part B is provided as a supply, and in the inspection of Part C of “CONTENTS OF OPERATION,” consumable(s) required as a result of the inspection of Part C are provided as supplies. Execution of a replacement of Part A, a replacement of Part B, and an inspection of Part C as “CONTENTS OF OPERATION” in this Task C of “TASK NAME” is entirely matters within the scope of the contract.

FIG. 3C shows an operation plan where, for the task names shown in the provided service/parts list illustrated in FIG. 3B, execution times (execution years) of task names to be executed during a long term contract have been arranged by years of execution. Namely, for a stable operation of equipment to be an object (for example, a steam turbine of a thermal power plant), a plan to execute the operations listed in FIG. 3B is shown as year-based plan as shown in FIG. 3C. According to this FIG. 3C, the term of a contract of ten years is adopted as an example. In FIG. 3C, for example, Task A of “TASK NAME” is to be executed in the first, third, and seventh years of the ten-year term of a contract, Task B of “TASK NAME” is to be executed in the fifth year, and Task C of “TASK NAME” is to be executed in the tenth year.

FIG. 3D shows an example of performance guarantees in a business (for example, maintenance/inspection and repair works in general of equipment delivered in a thermal power plant) for a complex total business structure (for example, a thermal power plant business), that is, a table of a year-based operating rate guarantee plan during a long term contract. This operating rate guarantee plan in FIG. 3D is expressed as guaranteed figures of operating rates of the object equipment during the term of a contract. Namely, as the guaranteed figures of operating rates of the object equipment during the term of a contract, operating rates guaranteed in the respective years are defined while taking the operation plan of FIG. 3C into consideration.

Meanwhile, as described above, the task requirement defining section 102 defines contents of a contract while decomposing the same into units of tasks for which risks can be individually assessed, based on data regarding the business contents stored in the project data storing section 101. Defining while decomposing into units of tasks by this task requirement defining section 102 means to set, for data regarding business contents (for example, maintenance/inspection and repair works in general of equipment delivered in a thermal power plant) in a complex total business structure (for example, a thermal power plant business), whether or not to include the respective contents in the contract or preconditions in a case where those are undertaken within the scope of the contract so as to structurally clarify the contents and scope of the contract. This data by tasks is what is referred to as task units. This data to show as to whether or not to include the contents in the contract is shown with FIG. 3A and FIG. 3B. Namely, this setting as to include/not include the contents in the contract may be provided, as shown in FIG. 3A, at a stage of the service list, or as shown in FIG. 3B, at a stage of the contents of operation and provided parts list.

In addition, for example, when respective data regarding business contents (for example, maintenance/inspection and repair works in general of equipment delivered in a thermal power plant) in a complex total business structure (for example, a thermal power plant business) are undertaken as data within the scope of the contract, preconditions therefor may be provided as an order of tasks in the operation plan of FIG. 3C or plan conditions such as, for example, “Task B is not executed for two years after execution of Task A.” Here, task units are, in this example, data of Task A and inputted related conditions thereof unified as units. These task units are used for corresponding to cost and risk data (linking between tasks and related events) in the risk type determining section to be described later.

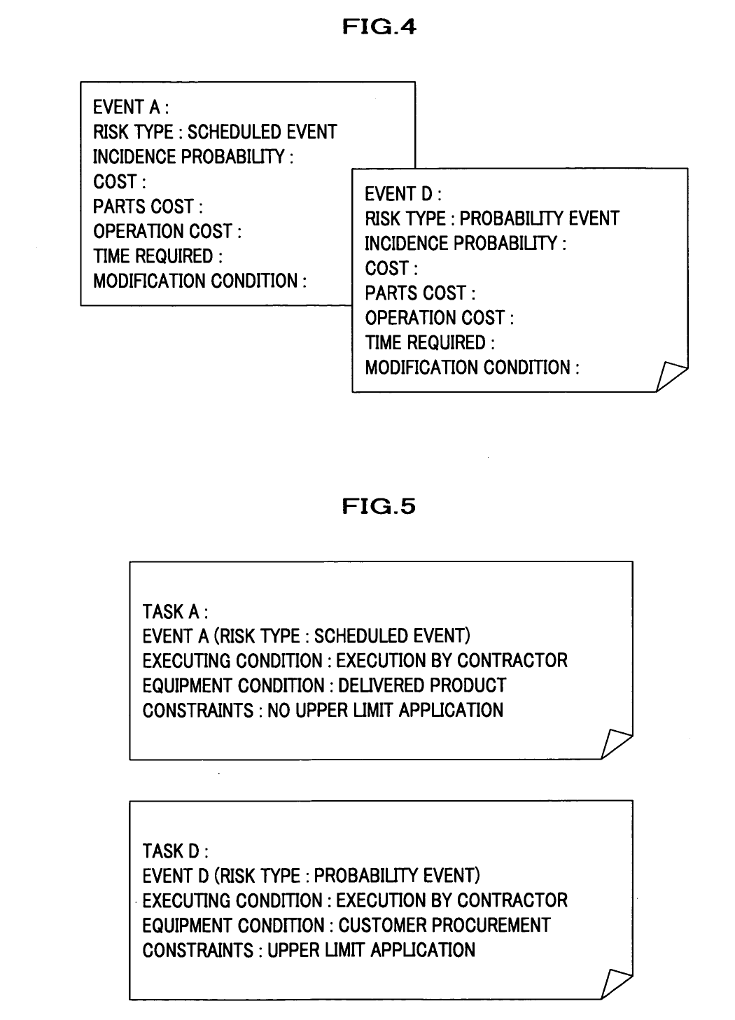

FIG. 4 shows an example where cost and risk information regarding tasks (contents of execution) which occur during the term of a contract concerning business contents (for example, equipment delivered in a thermal power plant and its maintenance/inspection and repair works in general) for a complex total business structure (for example, a thermal power plant business) stored in the cost and risk data storing section 103 has been sorted by events assumed in the business to be an object.

In the cost and risk information stored in this cost and risk data storing section 103, risk types of the assumed events can be classified into types, such as, for example, a “scheduled event” (risk type of Task A in FIG. 4) included in planned operations and a “probability event” (risk type of Task A in FIG. 4) which may occur in an unscheduled manner such as a failure or accident. Since this “scheduled event” (risk type of Task A in FIG. 4) corresponds to Task A which is executed based on the operation plan as shown in FIG. 3C, an incidence probability thereof illustrated in FIG. 4 is given by a function of time to become “1” at a time of execution (at the time of installation) and “0” at other times.

In addition, a “parts cost” illustrated in FIG. 4 is a cost which arises according to parts provided based on planned contents of operation, and an “operation cost” illustrated in FIG. 4 is a cost which arises according to contents of operation carried out based on planned contents of operation. The “parts cost” and “operation cost” are, while assigning originally estimated values as expected values, given as probability distributions including variations with defects of provided parts and operations taken into consideration. Furthermore, a “time required” illustrated in FIG. 4 is a time to cope with the concerned event, and is a time for which object equipment or an object facility has been stopped, and similar to the “cost,” while assigning an originally estimated time as an expected value, this is given as a probability distribution including variations with defects of provided parts and operations taken into consideration, for example. As such, for the distributions of the “cost” and “required time,” data prepared in advance based on performance is used, however, these may be changed according to conditions provided by the contract, such as qualities of operators and procurement sources of supplies. In order to cope with this change according to conditions, definition by a modification factor to give a change in a forecasted value according to conditions is possible.

On the other hand, the “probability event” (risk type of Task D in FIG. 4) illustrated in FIG. 4 means an event which occurs in an unscheduled manner during the term of a contract, and an “incidence probability” thereof illustrated in FIG. 4 is given as a function dependent on an elapse of time from a start of operation of object equipment or a replacement of an object part as a starting point, operating conditions of object equipment and the like. And, if an assumed event is a failure of specific equipment, this can be referred to as a failure probability. The “parts cost,” “operation cost,” and “time required” incidental to this “probability event” (risk type of Task D in FIG. 4) are costs which arise according to contents of operation and provided parts necessary to cope with this “probability event” and a time for which object equipment or an object facility has been stopped, and are given as probability distributions based on past performance. As such, for the distributions of the “cost” and “required time,” data prepared in advance based on performance is used, however, this may be changed according to conditions provided by the contract, such as qualities of operators and procurement sources of supplies. In order to cope with this change according to conditions, definition by a modification factor to give a change in a forecasted value according to conditions is possible.

FIG. 5 shows examples showing “task requirements” judged by the risk type determining section 104 and correspondences between the task units defined by the task requirement defining section 102 and “assumed events” stored in the cost and risk data.

In this risk type determining section 104, risk types of task requirements are judged by corresponding the task unit as described above defined by the task requirement defining section 102 with “assumed events” stored in the cost and risk data. In addition, information on matters which cause a change in a cost assessment, such as operator classifications, equipment suppliers, and presence of an upper limit application to the cost, is inputted. For the correspondences illustrated in FIG. 5, for example, by first referring to data “whether or not included in the contents of the contract” in task units, and next, only for tasks which are included, comparing and corresponding precondition data in the task units with condition data of respective events of cost and risk data, such a judgment as to “Task A corresponds to Event A” can be made, and a risk type is classified as a “scheduled event.”

In addition, the information on matters which cause a change in a cost assessment is used for defining a modification factor to revise the degree of a change in cost. Thereby, tasks to be considered during the term of a contract, statistical data necessary for a risk assessment, and information concerning a modification factor according to contractual conditions are defined, and are forwarded to the total cost and risk assessing section 105.

The total cost and risk assessing section 105 assesses risks for all tasks from commencement to termination of the contract in order of execution. Thereby, goods and operation costs of all tasks during the term of a contract where changes in the incidence probabilities of subsequent unplanned events owing to execution of individual tasks have also been taken into consideration, and probability distributions of business performance can be calculated. Furthermore, the business performance is converted into amounts of compensation or incentives by checking the same against performance guarantee conditions, and are made into a total cost together with the goods and operation costs.

Here, since the total cost and risk is changed depending on a difference in definitions of task requirements to be units of risk assessment, these can be classified into contractor costs owing to tasks responsible by a contractor under the contractual conditions and costs and risks not responsible by the contractor. Thereby, it becomes possible for a business contractor to calculate a loss risk by comparing the contractor costs with a contract price and set an appropriate contract price.

In addition, since a change in the total cost and risk owing to a difference in definitions of task requirements can be calculated as responsiveness, an improvement in business contents such as a risk reduction by a combination of task contents or by a change in execution plans and an expansion of profit opportunities can be supported.

Furthermore, since costs and risks not responsible by a contractor can be regarded as customer risks, it becomes possible to calculate a difference in customer risk reduction effects owing to a difference in task contents or scopes of responsibilities. This makes it possible to quantitatively express a customer risk reduction effect, that is, a customer's merit owing to a business contract, thus power of explanation is increased.

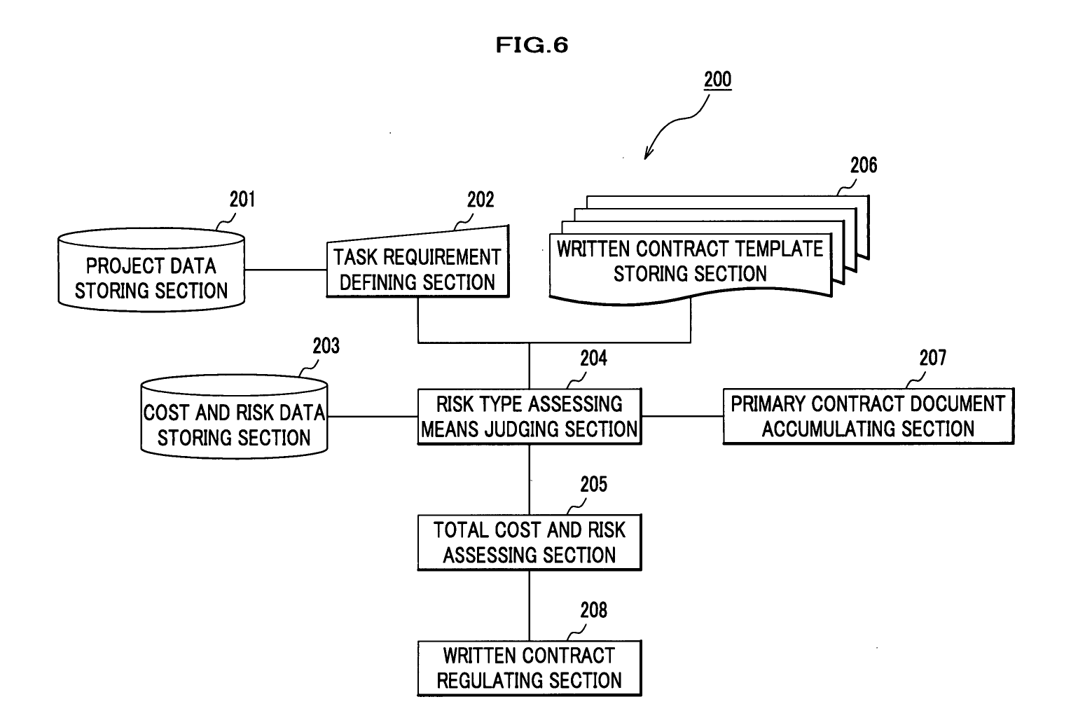

FIG. 6 shows another embodiment of a system for supporting business assessment according to the present invention.

In FIG. 6, a business assessment supporting system 200 includes a project data storing section 201, a task requirement defining section 202, a cost and risk data storing section 203, a risk type assessing means judging section (risk type determining section) 204, and a total cost and risk assessing section 205, and this point is similar to the business assessment supporting system 100 of FIG. 1. This business assessment supporting system 200 further includes a written contract template storing section 206, a primary contract document accumulating section 207, and a written contract regulating section 208.

This project data storing section 201 is for storing data regarding business contents, and the task requirement defining section 202 is for inputting thereinto business contents of an object of assessment, the cost and risk data storing section 203 is for storing cost and risk data regarding a business, the risk type assessing means judging section (risk type determining section) 204 is for judging risk types and assessing means of individual tasks, and the total cost and risk assessing section 205 is for calculating all costs and risks for a fixed period.

The written contract template storing section 206 is for storing standard contract documents, the primary contract document accumulating section 207 is for storing contract documents prepared based on the standard contract documents stored in the written contract template storing section 206, and the written contract regulating section 208 is for regulating contract documents stored in the primary contract document accumulating section 207 based on results obtained by calculating all costs and risks for a fixed period by the total cost and risk assessing section 205.

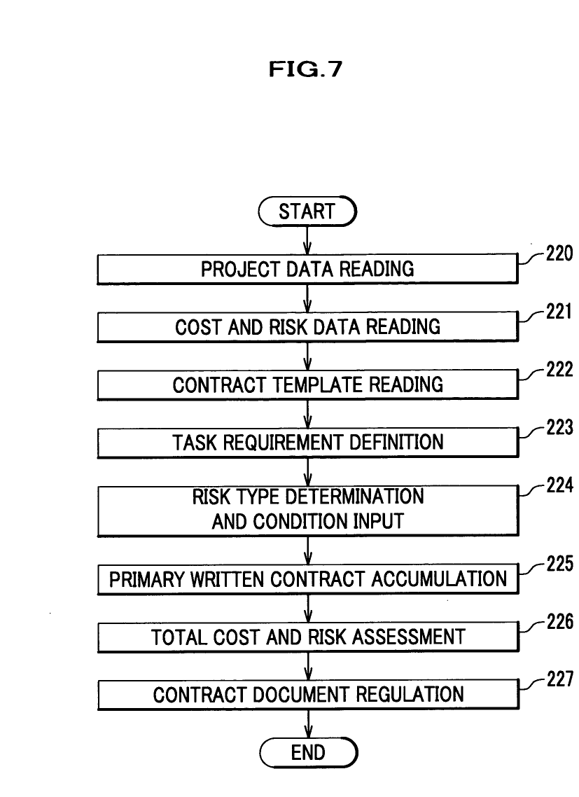

FIG. 7 shows an outline of contents of processes executed by the business assessment supporting system 200 illustrated in FIG. 6.

In FIG. 7, first, in step 220, data regarding business contents, that is, data regarding business contents (for example, equipment delivered in a thermal power plant and its maintenance/inspection and repair works in general) for a complex total business structure (for example, a thermal power plant business) is stored in the project data storing section 201. After storing data regarding a complex total business structure in the project data storing section 201 in this step 220, in step 221, cost and risk information regarding tasks (contents of execution) which occur during the term of a contract concerning the business contents (for example, equipment delivered in a thermal power plant and its maintenance/inspection and repair works in general) for the complex total business structure (for example, a thermal power plant business) is stored in the cost and risk data storing section 203.

After storing cost and risk information regarding tasks (tasks executed in advance in the business) which occur during the term of a contract concerning the business contents of the complex total business structure in the cost and risk data storing section 203 in this step 221, in step 222, standard contract documents corresponding to task contents defined in advance by the task requirement defining section 202 and contract provisions are stored in the written contract template storing section 206. After storing standard contract documents in the written contract template storing section 206 in this step 222, in step 223, contents of a contract are defined while being decomposed into units of tasks (execution of maintenance/inspections and repairs) for which risks can be individually assessed, by the task requirement defining section 202, based on data regarding the business contents (for example, maintenance/inspection and repair works in general of equipment delivered in a thermal power plant) in the complex total business structure (for example, a thermal power plant business) stored in the project data storing section 201. Thereby, the contents and scope of the contract are structurally clarified, and the respective tasks and cost and risk data can be linked.

After defining while decomposing contents of a contract into task units for which risks can be individually assessed, by the task requirement defining section 202, based on data regarding the business contents in the complex total business structure stored in the project data storing section 201 in this step 223, in step 224, the risk type determining section 204 determines assessments (task prices) while correlating respective tasks to be executed in the business (for example, equipment delivered in a thermal power plant and its maintenance/inspection and repair works in general) for the complex total business structure (for example, a thermal power plant business) which occur during the term of a contract defined in the task requirement defining section 202 with the cost and risk data stored in the cost and risk data storing section 203, determines risk assessing methods for the individual tasks, and gives necessary data to the total cost and risk assessing section 205.

After the risk type determining section 204 determines assessments while correlating respective tasks to be executed in the business for the complex total business structure which occur during the term of a contract defined in the task requirement defining section 202 with the cost and risk data stored in the cost and risk data storing section 203, it determines risk assessing methods for the individual tasks, and gives necessary data to the total cost and risk assessing section 205 in this step 224, in step 225, a document corresponding to the contents of definition of the contract in the task requirement defining section 201 is accumulated in the primary contract document accumulating section 212. The primary contract document accumulating section 212 is correlated with the risk type determining section 204, whereby a change in contract provisions is made to correspond to task requirements, which are also units of risk assessment. Thereby, in the primary contract document accumulating section 212, a text where provisions corresponding to tasks to be executed based on the contract have been thoroughly described is accumulated.

After accumulating a document corresponding to the contents of a definition of contents of a contract in the task requirement defining section 201 in the primary document accumulating section 212 in this step 225, in step 226, all costs and risks (failure rates) during the term of a contract regarding business contents for a fixed period are calculated by the total cost and risk assessing section 205. In addition, a change in contract provisions is reflected in a risk calculation of task requirements, thus it becomes possible to assess a change in the total cost owing to a change in provisions. After examining conditions and prices by a repetition of a change in the contract conditions and provisions and a cost and risk assessment and determining conditions to be described in a written contract in this step 226, in step 227, a format as being a document is regulated so as to prepare a written contract in the written contract regulating section 208.

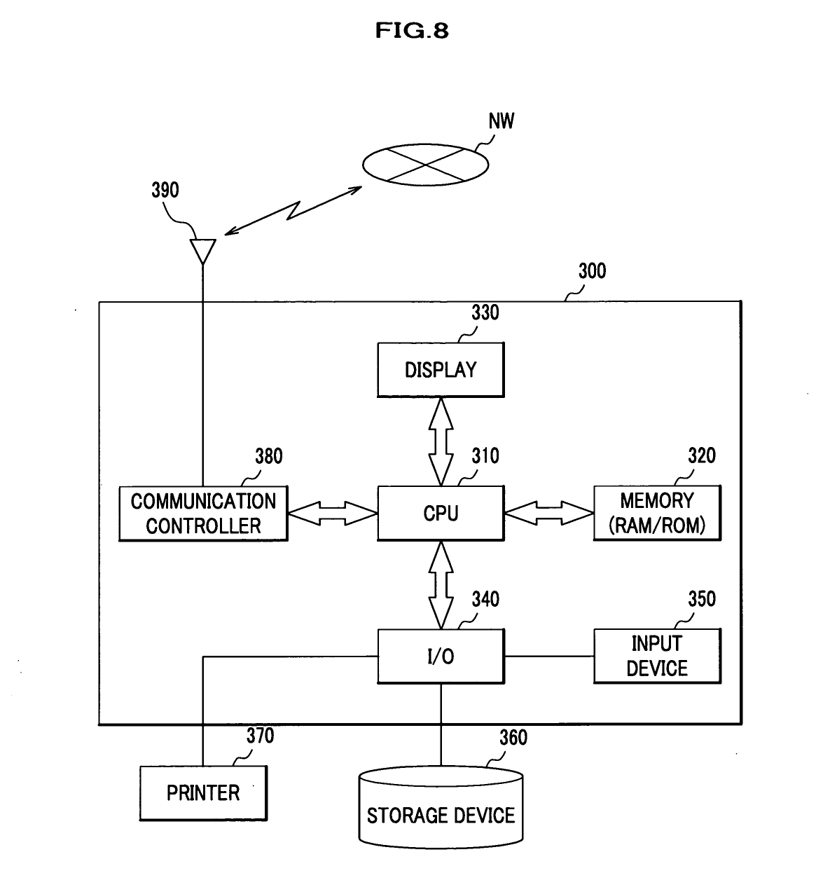

FIG. 8 shows a concrete hardware configuration of an information processor for supporting a business assessment in the business assessment supporting system 100 and business assessment supporting system 200.

In FIG. 8, an information processor 300 has a CPU 310, and to this CPU 310, a memory (RAM/ROM) 320, a display 330, and an I/O (input/output circuit) 340 are connected via bus lines. In addition, to the I/O (input/output circuit) 340, input device 350, a storage device 360, and a printer 370 are connected.

The CPU 310 is for controlling the memory (RAM/ROM) 320, display 330, and I/O (input/output circuit) 340, respectively, to write data into the storage device 360, rewrite data in the storage device 360, and read out data stored in the storage device 360. To this CPU 310, a communication controller 380 is connected via a bus line. To this communication controller 380, an antenna 390 is connected, thus this communication controller 380 is communicable with external user terminals (not shown) from the antenna 390 via a network NW. Accordingly, the communication controller 380 is driven when sending information to a user terminal via the network NW to transmit information to the user terminal, receiving information transmitted from a user terminal from the antenna 390 via the network NW to write necessary data into the storage device 360, and transmitting a radio wave from a user terminal via the network NW to the communication controller 380 to read out data stored in the storage device 360.

In addition, the display 330 is for displaying data stored in the storage device 360 on a screen. In addition, the memory (RAM/ROM) 320 has a function to store a program to start up the CPU 310 and make the same perform predetermined control, to primary store necessary data for a calculation inside the CPU 310, and to primary store calculation results.

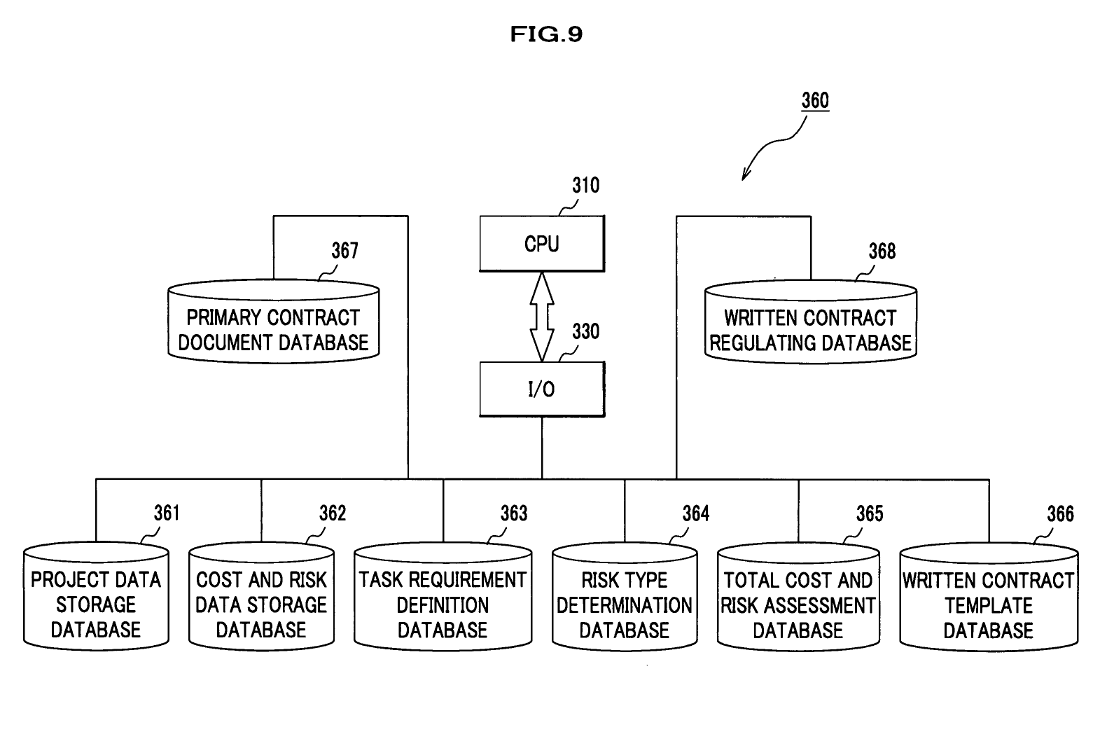

In addition, the storage device 360 is for storing information inputted into the CPU 310 via the I/O (input-output circuit) 340 from the input device 350 after processing the same in the CPU 310 and for storing calculation results processed in CPU 310. For this storage device 360, administration by databases (DBS) is provided. Namely, the storage device 360 may be individually administered, as shown in FIG. 9, by databases of a project data storage database 361, a cost and risk data storage database 362, a task requirement definition database 363, a risk type determination database 364, a total cost and risk assessment database 365, a written contract template database 366, a primary contract document database 367, and a written contract regulating database 368.

The project data storage database 361 is for storing data regarding business contents (for example, equipment delivered in a thermal power plant and its maintenance/inspection and repair works in general) for a complex total business structure (for example, a thermal power plant business) in a form compiled into a database, and the cost and risk data storage database 362 is for storing regarding tasks (contents of execution) which occur during the term of a contract concerning business contents (for example, equipment delivered in a thermal power plant and its maintenance/inspection and repair works in general) for a complex total business structure (for example, a thermal power plant business) in a form compiled into a database. In addition, the task requirement definition database 363 is for storing an object of assessment (for example, periodic inspection times of a turbine used for a thermal power plant business, replacement times of repaired parts and the like) for business contents (for example, maintenance/inspection and repair works in general of equipment delivered in a thermal power plant) in a complex total business structure (for example, a thermal power plant business) in a form compiled into a database.

Furthermore, the risk type determination database 364 is for storing contents of determination of assessments (task prices) while correlating respective tasks to be executed in a business (for example, equipment delivered in a thermal power plant and its maintenance/inspection and repair works in general) for a complex total business structure (for example, a thermal power plant business) which occur during the term of a contract with cost and risk data in a form compiled into a database. In addition, the total cost and risk assessment database 365 is for storing calculation results of all costs (expenses required for maintenance/inspection and repair works) and risks (failure rates) for a fixed period (for example, the term of a contract regarding business contents (for example, equipment delivered in a thermal power plant and its maintenance/inspection and repair works in general) of a complex total business structure (for example, a thermal power plant business)) in a form compiled into a database.

Then, the written contract template database 366 is for storing a plurality of standard contract document templates in a form compiled into a database. In addition, the primary contract document database 367 is for storing an unrevised primary contract document prepared based on various types of data in a form compiled into a database in a form compiled into a database. In addition, the written contract regulating database 368 is for storing a final written contract obtained by revising an unrevised primary contract document prepared based on various types of data in a form compiled into a database.

As such, the CPU 310 of the information processor 300 illustrated in FIG. 8 realizes various functions for supporting business assessment by executing programs loaded in the memory (RAM/ROM) 320. In the memory (RAM/ROM) 320, programs to be executed by the CPU 310, data used for an arithmetic processing and the like are stored.

Here, the business assessment supporting systems 100 and 200 can be realized by a single information processor. However, the present invention is not limited hereto. By a plurality of information processors, a plurality of functions for a business assessment can be divided and shared between the different information processors. In addition, it is also possible to process identical functions in parallel by a plurality of information processors. Furthermore, it is also possible to connect a plurality of information processors via a network to carry out a processing.

According to the present embodiment, it becomes possible, for the entire period of business, to support a contract price setting based on a cost and risk assessment including not only scheduled contents of tasks and contents of tasks to cope with unscheduled events, but also provision costs for goods and operations which can occur during the term of a contract.

In addition, according to the present embodiment, it becomes possible to assess an influence of failures, accidents, and countermeasures against these on performance of object equipment and an object facility and business results so as to support a setting of guaranteed performance, amounts of compensation, and incentives.

Furthermore, according to the present embodiment, it becomes possible, for the entire period of business, to support service business operations by showing a customer risk reduction effect in addition to scheduled contents of tasks and contents of tasks to cope with unscheduled events.

Furthermore, according to the present embodiment, it becomes possible to support preparation of a written contract in which the scope of and preconditions for services provided, the scope of responsibilities of a service provider and a service receiver, contents of guarantees and the like have been clearly described.

Furthermore, according to the present embodiment, it becomes possible to support a contract price setting by quantitatively assessing costs and risks of a business including at least scheduled tasks, tasks to cope with unscheduled events, and a performance guarantee.

Still furthermore, according to the present embodiment, it becomes possible to show a customer risk reduction effect of a contract by quantitatively assessing costs and risks of a business including at least scheduled tasks, tasks to cope with unscheduled events, and a performance guarantee.

Moreover, according to the present embodiment, it becomes possible to prepare a written contract in which the scope of and preconditions for services provided, the scope of responsibilities of a service provider and a service receiver, contents of guarantees and the like have been clearly described.

What is claimed is:

1. An assisting system for pricing products and maintenance and administration service costs, included in a business assessment supporting system for supporting preparation of a written business contract by quantitatively assessing costs and risks which may occur for a fixed period of business from a start of business based on business plans, which assisting system comprising:
a project data storing section for storing data regarding contents of a business of a complex total business structure;
a task requirement defining section for decomposition into task units for which risks can be individually assessed based on data regarding contents of a business of a complex total business structure stored in the project data storing section;
a cost and risk data storing section for storing cost and risk information regarding tasks to be executed in the business of a complex total business structure which occur during the term of a contract;
a risk type determining section for determining assessing means while correlating respective tasks to be executed in the business of a complex total business structure which occur during the term of a contract defined by the task requirement defining section, with cost and risk data stored in the cost and risk data storing section; and
a total cost and risk assessing section for calculating tasks to be executed in the business of a complex total business structure which occur during the term of a contract.

2. The assisting system according to claim 1, wherein
the project data stored in the project data storing section includes contents of provision of goods and service operations, provision plans of the contents, and definitions of guarantees and incentives for the contents or business performance.

3. The assisting system according to claim 1, wherein
requirements to be inputted into the task requirement defining section include constraints including scopes and conditions of provision of goods and service operations, an order of provision, and upper and lower limits of guarantees and incentives for business performance.

4. The assisting system according to claim 1, wherein
cost and risk data regarding a business to be stored in the cost and risk data storing section includes either: a probability distribution data of costs resulting from scheduled events in the business contents of the total business structure, data of an influence on a business performance owing to the scheduled events, and modification factors of the respective data according to executing conditions of tasks to be executed in the business of a complex total business structure; or a probability distribution data of incidence probabilities of unscheduled events in the business contents of the total business structure and costs resulting from the events, data of an influence on a business performance owing to the events, data of an influence on the business performance owing to the scheduled events, and modification factors of the respective data according to executing conditions of tasks to be executed in the business of a complex total business structure; and
in the risk type determining section, risk types are determined while corresponding contents of tasks to be executed for scheduled or unscheduled events in the business contents of the total business structure with respective events which occur in the business contents of the total business structure, and task executing conditions are inputted.

5. The assisting system according to claim 4, wherein
risk types determined by the risk type determining section include at least risks resulting from contents of tasks executed in a planned manner and risks resulting from contents of tasks to cope with unplanned events.

6. The assisting system according to claim 1, wherein
the total cost and risk assessing section assesses tasks for scheduled events during a term of execution of the business of a complex total business structure and tasks for unscheduled events during the term of execution of the business of a complex total business structure in order of execution,
estimates a distribution of costs resulted from execution of tasks for scheduled events during the term of execution of the business of a complex total business structure, a distribution of costs resulted from execution of tasks for unscheduled events during the term of execution of the business of a complex total business structure, a distribution of the influence on the business performance owing to execution of tasks for scheduled events during the term of execution of the business of a complex total business structure, and a distribution of an influence on the business performance owing to execution of tasks for unscheduled events during the term of execution of the business of a complex total business structure, and
estimates a compensation cost by checking the calculated influence on the business performance of the business of a complex total business structure against guarantee conditions,
so that a total cost and risk is estimated to calculate a contractor loss distribution according to a contract price and a customer risk reduction effect according to contract conditions.

7. The assisting system according to claim 1, wherein
the total cost and risk assessing section is for calculating a difference in total costs owing to a difference in definitions of task requirements inputted into the task requirement defining section and outputting the same as responsiveness of task requirements to a total cost.

8. The assisting system according to claim 1, further comprising:
a written contract template storing section for storing contract documents corresponding to standard task contents of the business of a complex total business structure;
a written contract linking means for calling up a corresponding contract document out of written contract templates stored in the written contract template storing section according to requirements inputted into the task requirement defining section and preparing a written contract requirement; and
a written contract regulating section for regulating a written contract format by accepting an addition and revision to the written contract requirement prepared by the written contract linking means.

9. The assisting system according to claim 1, further comprising:
a computer for arithmetic processing; a storage device for storing programs and data; an input/output interface for giving and receiving data with respect to the outside; and a display for displaying processing results of the computer, wherein
the storing device stores requirement data regarding the business contents and cost and risk numerical data regarding the business while correlating the same with task contents executed under a business contract,
the computer executes various types of arithmetic processing based on data inputted and outputted via the input/output interface and task contents stored in the storage device, and
the computer causes the display to display a total cost and risk of a contract on selected conditions upon accepting a condition input regarding task contents via the input/output interface.

10. An assisting method for pricing products and maintenance and administration service costs, included in a business assessment supporting method for supporting preparation of a written business contract by quantitatively assessing costs and risks which may occur for a fixed period of business from a start of business based on business plans, which assisting method comprising:
a project data storing step of storing data regarding contents of a business of a complex total business structure;
a task requirement defining step of decomposition into task units for which risks can be individually assessed based on data regarding contents of a business of a complex total business structure stored in the project data storing step;
a cost and risk data storing step of storing cost and risk information regarding tasks to be executed in the business of a complex total business structure which occur during the term of a contract;
a risk type determining step of determining assessing means while correlating respective tasks to be executed in the business of a complex total business structure which occur during the term of a contract defined by the task requirement defining step with cost and risk data stored in the cost and risk data storing step; and
a total cost and risk assessing step of calculating tasks to be executed in the business of a complex total business structure which occur during the term of a contract.

11. The assisting method according to claim 10, further comprising:
a written contract template storing step of storing contract documents corresponding to standard task contents of the business of a complex total business structure;
a written contract linking step of calling up a corresponding contract document out of written contract templates stored in the written contract template storing step according to requirements inputted into the task requirement defining step and preparing a written contract requirement; and
a written contract regulating step of regulating a written contract format by accepting an addition and revision to the written contract requirement prepared by the written contract linking step.

12. The assisting method according to claim 10, further comprising:
a computer for arithmetic processing; a storage device for storing programs and data; an input/output interface for giving and receiving data with respect to the outside; and a display for displaying processing results of the computer, wherein
the storing device stores requirement data regarding the business contents and cost and risk numerical data regarding the business while correlating the same with task contents executed under a business contract,
the computer executes various types of arithmetic processing based on data inputted and outputted via the input/output interface and task contents stored in the storage device, and
the computer causes the display to display a total cost and risk of a contract on selected conditions upon accepting a condition input regarding task contents via the input/output interface.
